(19) United States
(12) Patent Application Publication
(10) Pub. No.: US 2006/0215296 A1
(43) Pub. Date: Sep. 28, 2006

(54) Bidirectional referenceless communication circuit

(75) Inventor: Ryan S. Latchman, Markham (CA)

Correspondence Address: STEPHEN D. SCANLON, JONES DAY, 901 LAKESIDE AVENUE, CLEVELAND, OH, 44114, US

(73) Assignee: Gennum Corporation

(21) Appl. No.: 11/088,705

(22) Filed: Mar. 24, 2005

(51) Int. Cl. G11B 5/09

(52) U.S. Cl. 360/51

(57) ABSTRACT

A referenceless clocking generator circuit in a bidirectional communication circuit is operable to receive a first clock signal recovered from a transmit clock and data recovery circuit and a second clock signal recovered from a received clock and data recovery circuit and compare the frequency of the second clock signal to the first clock signal to generate a referenceless clocking signal based on the comparison.

This disclosure generally relates to bidirectional communication links. In particular, this disclosure is directed to referenceless generation of a centering reference for a receive link circuit, such as a receive clock and data recovery circuit.

A bidirectional communication circuit may be configured to transmit data over a first data channel and receive data over a second data channel. The first and second data channels may collectively form a bidirectional channel, such as a SONET channel, a fiber optic channel, or any other bi-directional communication channel. The data may be transmitted and received over the first and second channels by a transmit clock and data recovery (CDR) circuit and a receive CDR, respectively. The transmit CDR and receive CDR may be configured to utilize a reference clock to obtain a correct locking frequency. The reference clock is used to provide approximate frequency information to a voltage controlled oscillator (VCO) within the CDR circuit. The frequency information is typically used to facilitate lock during an initial start up or under very jittery conditions. Once the locking frequency is obtained, a phase detector within the CDR circuit establishes and maintains a phase locked condition.

Disclosed herein is a bidirectional referenceless communication circuit that has the ability to provide approximate frequency information to the VCO within the receive CDR circuit without utilizing a reference clock. This capability results in a more robust bidirectional communication link, as the receive CDR circuit may obtain and maintain lock without a reference clock or upon failure of the reference clock. The bidirectional referenceless communication circuit includes a referenceless clocking generator circuit operable to receive a first clock signal recovered by a transmit CDR circuit and a second clock signal recovered by a received CDR circuit and compare the frequency of the second clock signal to the first clock signal to generate a referenceless clocking signal based on the comparison.

### DRAWINGS

FIG. 1 is a block diagram of a prior art bidirectional communication circuit;

FIG. 2 is a block diagram of a prior art clock and data recovery circuit;

FIG. 3 is a block diagram of an example bidirectional referenceless communication circuit;

FIG. 4 is a block diagram of another example bidirectional referenceless communication circuit;

FIG. 5 is a block diagram of a third example bidirectional referenceless communication circuit; and

FIG. 6 is a block diagram of a fourth example bidirectional referenceless communication circuit.

### DETAILED DESCRIPTION

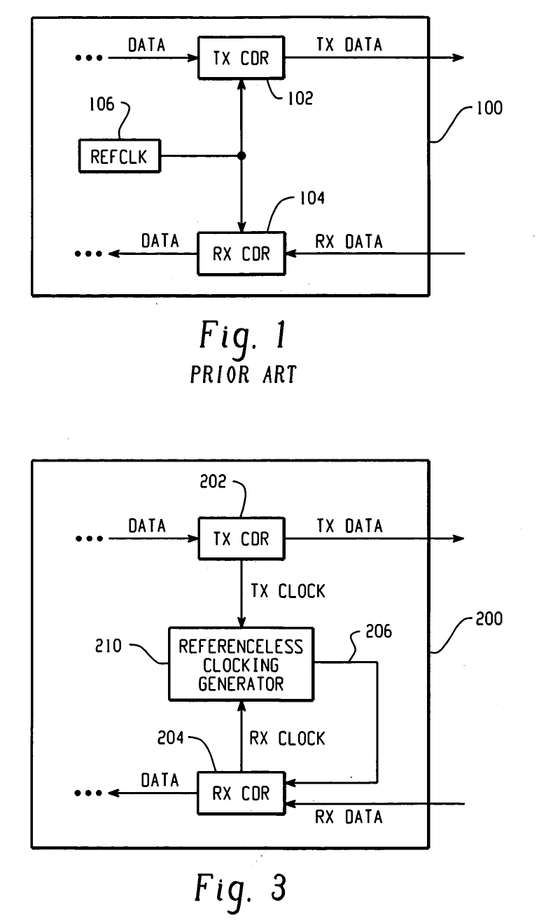

FIG. 1 is a block diagram of a prior art bidirectional communication circuit 100. The circuit 100 comprises a transmit CDR 102, a receive CDR 104, and a reference clock 106. The circuit 100 may be implemented in a semiconductor integrated circuit, such as an application specific integrated circuit (ASIC) chip. The reference clock 106 provides a reference clock signal to the transmit CDR 102 and the receive CDR 104. The transmit CDR 102 receives data to be transmitted over a transmit channel, locks to the data received, and transmits the data over the transmit channel as transmission data (TX DATA). The transmission data is typically clocked according to a clock signal that is generated in response to the reference clock 106.

Similarly, the receive CDR 104 receives receive data (RX DATA) over a receive channel, recovers the clock, and relocks the received data. Clock recovery of the receive data is facilitated by the reference clock 106.

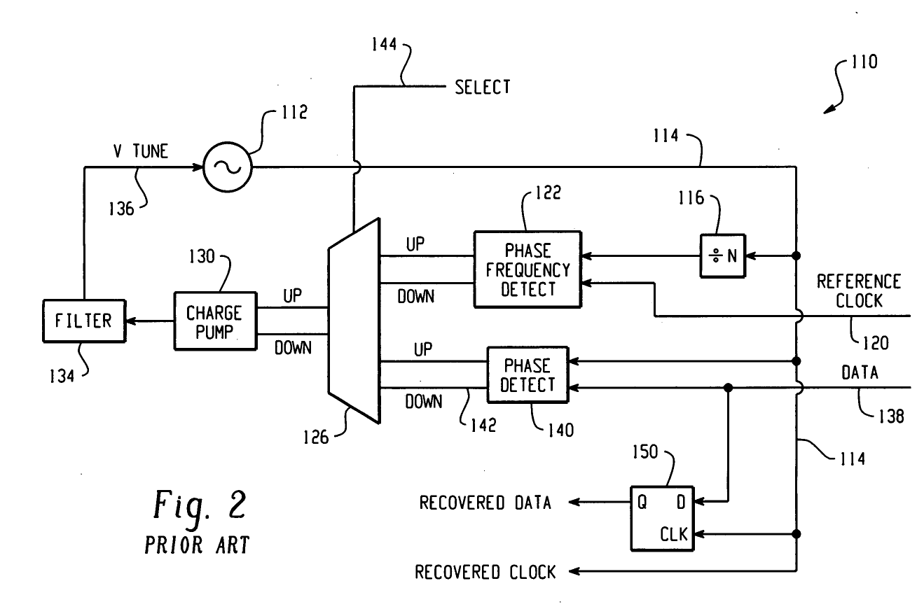

FIG. 2 is a block diagram of a prior art CDR circuit 110. The CDR circuit 110 may be used to realize the transmit CDR 102 and/or the receive CDR 104 of FIG. 1. A VCO 112 provides a clock signal 114 that is input to a divide by N circuit 116. The divide by N circuit 116 divides the clock signal 114 frequency by N to provided a divided reference frequency. A reference clock signal 120 is compared to the divided reference frequency in a phase-frequency detector circuit 122. If the divided reference frequency is lower than or higher than the clock frequency, the detector 122 asserts an UP or DOWN signal, respectively, through multiplexer 126 to cause a charge pump 130 to increase a tune voltage for controlling the VCO 112. The charge pump output is input to a filter 134 and the filtered tuning voltage V_{Tune} 136 is input to the VCO 112 to adjust the clock frequency and obtain a frequency lock. In this manner, the VCO 112, frequency divider 116, detector 122, charge pump 130 and filter 134 form a closed loop for dynamically adjusting the VCO frequency to N times the reference clock signal 120 frequency.

Matching the frequency of a serial data stream is insufficient to accurately recover the received data because the precise phase of the data stream must be taken into account as well. To properly recover the received clock and data, the incoming data stream 138 is compared to the clock signal 114 in a phase detector circuit 140. If a given transition or edge of the clock signal 114 lags or leads a corresponding edge of the receive data stream 138, then the detector circuit 140 outputs an UP or DOWN signal, respectively. This control signal is provided through a multiplexer 126 to the charge pump 130 to affect a slight upward or downward adjustment of the tune voltage V_{Tune} 136. This adjustment slightly increases or decreases the frequency of the clock signal 114 generated by the VCO 112 to synchronize the clock signal 114 with the received data stream 138.

The frequency detector 122 thus coarsely adjusts the VCO loop in order to drive the VCO 112 to an approximate desired frequency, and the phase detector 140 adjusts the phase of the clock signal 114 to synchronize it to the incoming data stream 138. When both loops are locked, the clock signal 114 provides the recovered clock signal and the recovered clock signal is used to clock the flip flop 150 to recover data from the incoming data stream.

The multiplexer 126 is arranged for controllably selecting the frequency detector 122 output or the phase detector 140 output as the control input to the charge pump 130 in response to a selection control signal 144. Generally, when the serial data stream 138 is being received, the clock signal 114 is at the correct frequency, i.e., the frequency of the serial data stream 138, and the multiplexer 126 selects the output of the phase detector 140 as a control input to the charge pump 130 to maintain synchronization between the recovered clock signal 114 and the data stream 138. If synchronization is lost, then the selection control signal 144 switches the multiplexer 126 to select the frequency detector 122 output as the control input to the charge pump 130 to force the VCO 112 to N times the reference clock signal 120 frequency.

Thus, the reference clock 120 is used to provide approximate frequency information to the VCO 112 when the correct locking frequency has not been established or is lost, such as may occur under noisy and/or jittery conditions. Typically the reference clock 120 primarily benefits the receive CDR circuit, as such noise and jitter is typically present in data received over a receive channel, but is not typically present in data that is to be transmitted over a transmission channel. Additionally, signal degradation in the transmit direction may be compensated for a priori (e.g., equalizing for a 30 millimeter electrical trace on a printed circuit board). Phase and frequency lock may thus often be obtained in the transmit CDR without a reference clock signal.

FIG. 3 is a block diagram of an example bidirectional referenceless communication circuit 200. The bidirectional referenceless communication circuit 200 comprises a transmit CDR 202, a receive CDR 204, and a references clocking generator 210. Because the transmit CDR 202 is able to lock reference-free to data to be transmitted, the transmit CDR 202 may recover the clock from the data to be transmitted and utilize the recovered transmission clock to provide clocking data for the receive CDR 204. Thus, an external reference clock is not required, as a reference signal may be provided by the transmit CDR 202.

The referenceless clocking generator circuit 210 receives a first clock signal (TX CLOCK) recovered by the transmit CDR 202 and a second clock signal (RX CLOCK) recovered by the receive CDR 204 and provides a referenceless clocking signal 206 to the receive CDR 204. The referenceless clocking signal 206 is utilized to adjust a VCO within the receive CDR 204 to a desired clock frequency when the correct locking frequency has not been established or is lost, such as may occur under very noisy and/or jittery conditions.

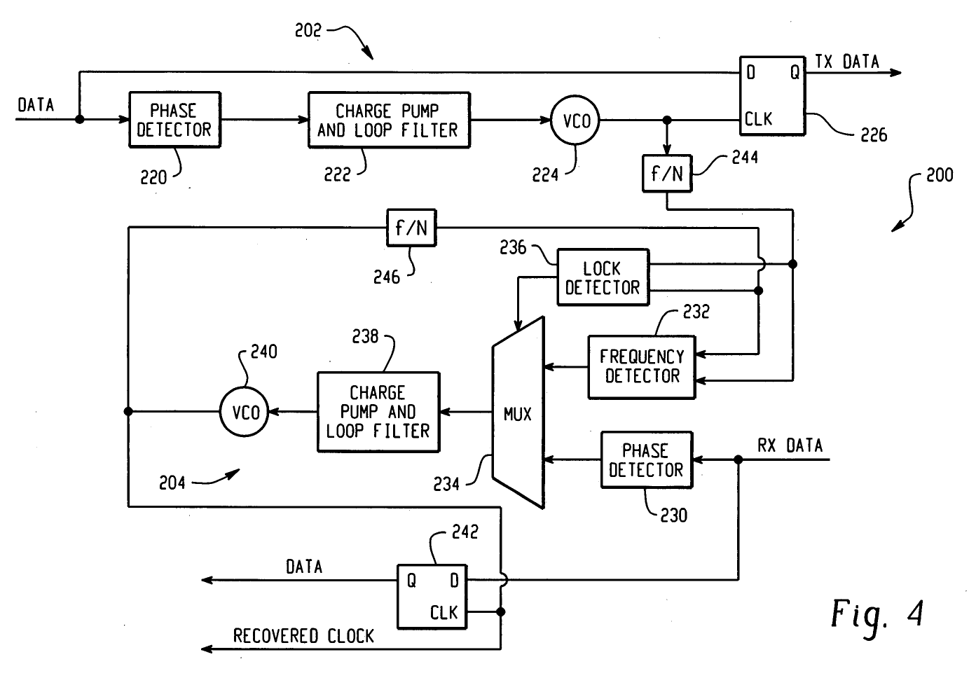

FIG. 4 is a block diagram of another example bidirectional referenceless communication circuit 200. The bidirectional referenceless communication circuit 200 includes a transmit CDR 202 comprising a phase detector 220, a charge pump and loop filter 222, a VCO 224, and a D-type flip-flop 226. The data input to the transmit CDR 202 is relatively free of transmission degradation, and thus the transmit CDR 202 may lock reference free to the data. Accordingly, the VCO 224 produces a first clock signal that may be utilized to generate a reference frequency.

The phase detector 230, charge pump and loop filter 238, VCO 240, and D-type flip flop 242 of the receive CDR 204 operate in a similar manner to the phase detector 220, charge pump and loop filter 222, VCO 224, and the D-type flip-flop 226 of the transmit CDR 202. When the receive CDR 204 is in a lock condition, the VCO 240 generates a second clock signal that is the recovered clock from the received data and reclocks the received data via the D-type flip-flop 242.

Because the receive data typically suffers from transmission degradation (e.g., noise and/or jitter), the receive CDR 204 may have difficulty in obtaining a lock condition. As described above, one method to facilitate phase and frequency lock is a reference signal. Accordingly, a referenceless clocking generator circuit may be provided that receives the first clock signal and the second clock signal and compares the frequency of the second clock signal to the first clock signal generates a referenceless clocking signal based on the comparison is provided. The referenceless clocking signal is utilized to facilitate phase and frequency lock in the receive CDR 204.

In the example of FIG. 4, the referenceless clocking generator circuit comprises a frequency detector 232 and frequency dividers 244 and 246. The frequency dividers 244 and 246 receive the first clock signal from the VCO 224 and the second clock signal from the VCO 240 and generated divided frequency reference signals. These divided frequency reference signals are compared in the frequency detector 232, which generates the referenceless clocking signal based on the comparison.

A multiplexer 234 selects one of the phase detector 230 output signal or the frequency detector 232 output signal based on a selection signal provided by a lock detector circuit 236. The lock detector circuit 236 determines whether the frequency of the VCO 240 signal is within an acceptable range of the frequency of the VCO 224 signal, e.g., +/−100 ppm. If the frequency of the VCO 240 signal is within the acceptable range of the frequency of the VCO 224 signal, then the lock detector circuit 236 determines that the VCOs 240 and 224 are frequency locked and generates a selection signal that causes the multiplexor 234 to provide the phase detector output 230 to the charge pump and loop filter 238. Thereafter, the phase detector 230 determines if a given transition or edge of the VCO 240 signal lags or leads a corresponding edge of the received data and drives the charge pump and loop filter 238 in response to slightly increase or decrease the frequency of the VCO 240 signal to maintain lock.

If, however, the frequency of the VCO 240 signal is not within the acceptable range of the frequency of the VCO 224 signal, then the lock detector circuit 236 determines that the VCO 240 is not frequency locked to VCO 224. Based on this determination, the lock detector circuit 236 generates a selection signal that causes the multiplexor 234 to provide the frequency detector 232 output to the charge pump and loop filter 238. The referenceless clocking signal output by the frequency detector 232 then drives the charge pump and loop filter 238 accordingly to drive the frequency of the VCO 240 signal to the frequency of the VCO 224 signal. Once frequency lock is obtained, control of the VCO 240 is returned to the phase detector 230.

In another example circuit, the lock detector circuit 236 determines if the first clock signal and second clock signal are frequency locked by measuring the magnitude of the referenceless clocking signal output by the frequency detector 232. In this example circuit, the lock detector circuit 236 need only receive the output of the frequency detector circuit 232 to make this determination, and need not directly monitor the signals from VCO 224 and VCO 240.

The referenceless clocking generator of FIG. 4 thus provides a frequency adjustment control signal to the receive CDR 204 without using an external reference clock. This capability results in a more robust bidirectional communication link, as the receive CDR 204 may obtain and maintain lock without a reference clock.

While the example referenceless clocking generator of FIG. 4 comprises frequency detector 232 and frequency dividers 244 and 246, other circuitry may also be used to generate the referenceless clocking signal. For example, circuitry that generates digital signals indicative of the frequencies of the signals generated by the VCOs 224 and 240 may be utilized. These digital values are then compared by a digital window comparator which may provide three-state output, the first state corresponding to the frequency of the VCO 240 signal being less than the frequency of the VCO 224 signal, the second state corresponding to the frequency of the VCO 240 signal being greater than the frequency of the VCO 224 signal, and the third state indicated that the VCO 224 and the VCO 240 are frequency locked. Other circuits and methods may also be used.

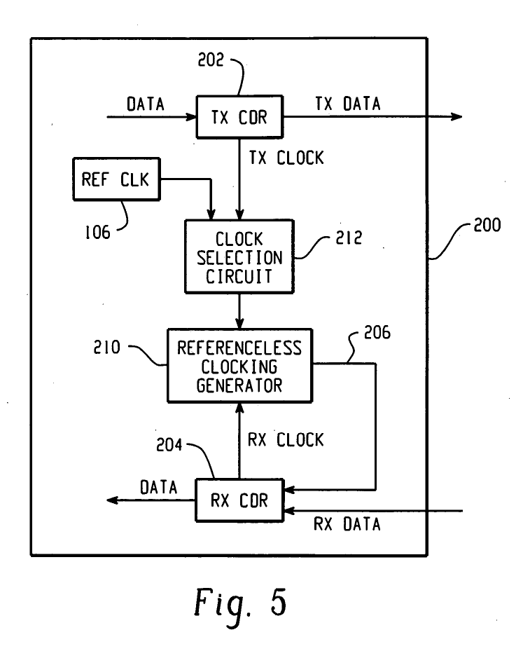

FIG. 5 is a block diagram of a third example bidirectional referenceless communication circuit 200. This example circuit includes a clock selection circuit 212 and a reference clock 106. The clock selection circuit 212 is configured to select the first clock signal (TX CLOCK) recovered by the transmit CDR 202 upon a loss of signal condition of the reference clock 106. The reference clock may also be used to facilitate locking of the transmit CDR 202, as described with respect to FIGS. 1 and 2 above. The clock selection circuit 212 may comprise a multiplexor and a clock monitoring circuit. The multiplexor receives the first clock recovered by the transmit CDR 202 and the reference clock 106, and the clock monitoring circuit 212 monitors the reference clock and maintains selection of the reference clock as long as it determines that the reference clock has not failed.

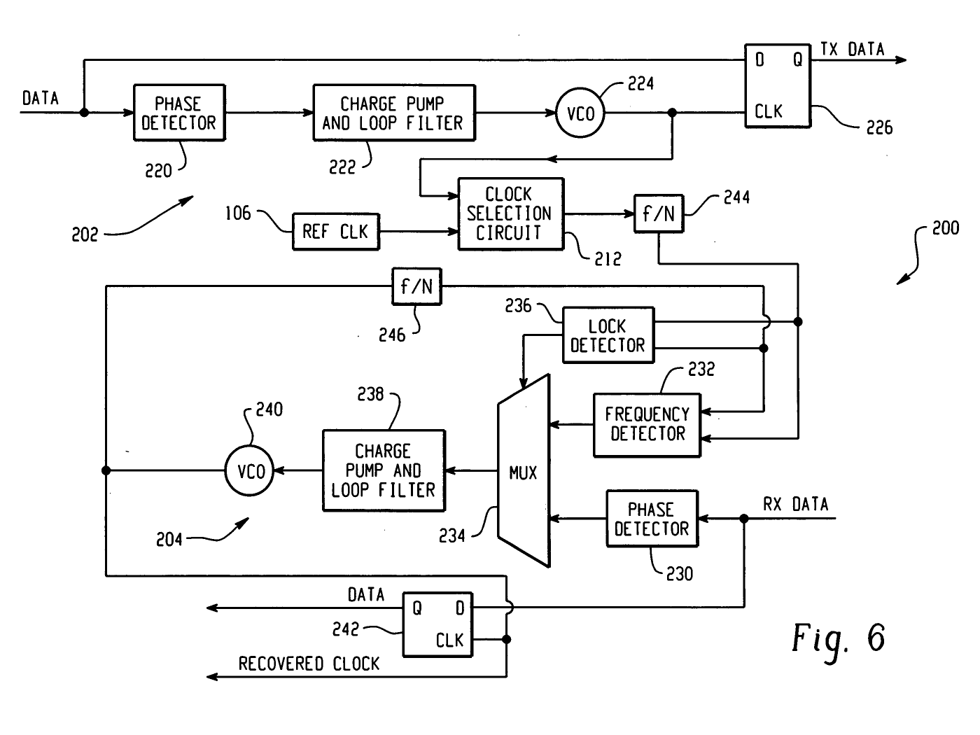

FIG. 6 is a block diagram of a fourth example bidirectional referenceless communication circuit 200. In this example, the referenceless clocking generator receives either the first clock recovered by the VCO 224 or the reference clock 106. This example circuit provides additional robustness, as the bidirectional communication link may obtain and maintain lock without a reference clock or upon failure of a reference clock.

In the example of FIG. 6, the reference clock 106 produces a clock signal having a frequency equal to the desired VCO frequency for the transmit and receive CDRs 202 and 204. By way of another example, the reference clock 106 may produce a clock signal having a frequency equal to the desired VCO frequency divided by N. The clock selection circuit 212 thus may bypass the frequency divider 244 if the reference clock 106 is selected.

This written description sets forth the best mode of the claimed invention, and describes the claimed invention to enable a person of ordinary skill in the art to make and use it, by presenting examples of the elements recited in the claims. The patentable scope of the invention is defined by the claims themselves, and may include other examples that occur to those skilled in the art. Such other examples, which may be available either before or after the application filing date, are intended to be within the scope of the claims if they have structural elements that do not differ from the literal language of the claims, or if they include equivalent structural elements with insubstantial differences from the literal language of the claims.

What is claimed is:

1. A bidirectional communication circuit, comprising:
a transmit clock and data recovery circuit operable to receive transmit input data, derive a first clock signal from the transmit input data, and transmit the transmit input data over a transmit channel;
a receive clock and data recovery circuit operable to receive receive input data over a receive channel and to receive a referenceless clocking signal, derive a second clock signal from the receive input data and the refrenceless clocking signal, and reclock the receive input data to generate reclocked data; and
a referenceless clocking generator circuit operable to receive the first clock signal and the second clock signal and compare the frequency of the second clock signal to the first clock signal and generate the referenceless clocking signal based on the comparison.

2. The bidirectional communication circuit of claim 1, wherein the referenceless clocking generator circuit comprises:
a first frequency divider circuit operable to receive the first clock signal and generate a first reduced clock signal;
a second frequency divider circuit operable to receive the second clock signal and generate a second reduced clock signal;
a frequency detector circuit operable to receive and compare the first and second reduced clock signals and generate the referenceless clocking signal based on the comparison.

3. The bidirectional communication circuit of claim 1, wherein the receive clock and data recovery circuit comprises:
a voltage controlled oscillator operable to receive an input control signal and generate the second clock signal in response to the input control signal;
a selector circuit operable to select and output one of a phase detector output signal and the referenceless clocking signal in response to a lock detection signal;
a charge pump and loop filter circuit operable to receive the output of the selector circuit and generate the input control signal in response to the output of the selector circuit;
a phase detector operable to receive the receive input data and the second clock signal and generate the phase detector output signal based on the phase relation between the receive input data and the second clock signal; and
a lock detector circuit operable to determine a frequency lock condition between the first clock signal and the second clock signal and generate the lock detection signal in response to the determination.

4. The bidirectional communication circuit of claim 3, wherein the lock detector circuit is configured to receive the first clock signal and the second clock signal and compare the first and second clock signals to determine the frequency lock condition.

5. The bidirectional communication circuit of claim 3, wherein the lock detector circuit is configured to receive the referenceless clocking signal and determine the frequency lock condition based on the referenceless clocking signal.

6. The bidirectional communication circuit of claim 2, wherein the transmit clock and data recovery circuit comprises:
a first voltage controlled oscillator operable to receive a first input control signal and generate the first clock signal in response to the first input control signal;
a first charge pump and loop filter circuit operable to receive a first detector control signal and generate the first input control signal in response to the first detector control signal; and
a first phase detector operable to receive the transmit input data and the first clock signal and generate the first phase detector control signal based on the phase relation between the transmit input data and the first clock signal.

7. The bidirectional communication circuit of claim 6, wherein the receive clock and data recovery circuit comprises:
a second voltage controlled oscillator operable to receive a second input control signal and generate the second clock signal in response to the second input control signal;
a selector circuit operable to select and output one of a second phase detector output signal and the referenceless clocking signal in response to a lock detection signal;
a second charge pump and loop filter circuit operable to receive a output of the selector circuit and generate the second input control signal in response to the output of the selector circuit;
a second phase detector operable to receive the receive input data and the second clock signal and generate the second phase detector output signal based on the phase relation between the receive input data and the second clock signal; and
a lock detector circuit operable to determine a frequency lock condition between the first clock signal and the second clock signal and generate the lock detection signal in response to the determination.

8. The bidirectional communication circuit of claim 1, wherein the referenceless clocking generator circuit comprises a clock selection circuit operable to receive the first clock signal and a reference clock signal and select one of the first clock signal or the reference clock signal for comparison to the second clock signal.

9. The bidirectional communication circuit of claim 8, wherein the clock selection circuit is configured to select the first clock signal upon a loss of signal condition of the reference clock.

10. The bidirectional communication circuit of claim 1, wherein the transmit input data the receive input data comprises SONET data.

11. A bidirectional communication method, comprising:
receiving transmit input data for transmission over a transmit channel;
deriving a first clock signal from the transmit input data;
receiving receive input data;
deriving a second clock signal from the receive input data and a referenceless clocking signal; and
comparing the frequency of the second clock signal to the first clock signal and generating the referenceless clocking signal based on the comparison.

12. The method of claim 11, wherein comparing the frequency of the second clock signal to the first clock signal and generating the referenceless clocking signal based on the comparison comprises:
frequency dividing the first clock signal to generate a first reduced clock signal;
frequency dividing the second clock signal to generate a second reduced clock signal;
comparing the first and second reduced clock signals to generate the referenceless clocking signal.

13. The method of claim 11, further comprising:
determining whether the first clock signal and second clock signal are frequency locked;
generating a lock detection signal in response to the determination;
detecting a phase difference between the second clock signal and the receive input data;
generating a phase difference control signal based on the detected phase difference; and
adjusting the second clock signal by one of the phase difference control signal and the referenceless clocking signal based on the lock detection signal.

14. The method of claim 13, wherein determining whether the first clock signal and second clock signal are frequency locked comprises comparing the first clock signal and the second clock signal.

15. The method of claim 13, wherein determining whether the first clock signal and second clock signal are frequency locked comprises measuring a magnitude of the referenceless clocking signal.

16. The method of claim 11, wherein comparing the frequency of the second clock signal to the first clock signal and generating the referenceless clocking signal based on the comparison comprises:
receiving a reference clock signal; and
selecting one of the reference clock signal and the first clock signal.

17. The method of claim 16, wherein selecting one of the reference clock signal and the first clock signal comprises selecting the first clock signal upon detecting a loss of signal condition of the reference clock signal.

18. A bidirectional communication circuit, comprising:
means for receiving transmit input data for transmission over a transmit channel;
means for deriving a first clock signal from the transmit input data;
means for receiving receive input data;
means for deriving a second clock signal from the receive input data and a referenceless clocking signal; and
means for comparing the frequency of the second clock signal to the first clock signal and for generating the referenceless clocking signal based on the comparison.

19. The circuit of claim 18, wherein the means for comparing the frequency of the second clock signal to the first clock signal and for generating the referenceless clocking signal based on the comparison comprises:
means for frequency dividing the first clock signal to generate a first reduced clock signal;
means for frequency dividing the second clock signal to generate a second reduced clock signal;
means for comparing the first and second reduced clock signals to generate the referenceless clocking signal.

20. The circuit of claim 18, wherein the means for comparing the frequency of the second clock signal to the first clock signal and for generating the referenceless clocking signal based on the comparison comprises means for selecting one of a reference clock signal and the first clock signal.
